(19) United States
(12) Patent Application Publication
(10) Pub. No.: US 2018/0238390 A1
(43) Pub. Date: Aug. 23, 2018

(54) METHOD FOR PRODUCING A TAPERED ROLLER ASSEMBLY, TAPERED ROLLER ASSEMBLY AND TAPERED ROLLER BEARING

(71) Applicant: Schaeffler Technologies AG & Co. KG, Herzogenaurach (DE)

(72) Inventors: Reinhard KICK-RODENBÜCHER, Nürnberg (DE); Markus MANTAU, Veitsbronn (DE); Andre SCHADE, Bamberg (DE)

(73) Assignee: Schaffler Technologies AG & Co., KG, Herzogenaurach (DE)

(21) Appl. No.: 15/753,355

(22) PCT Filed: Jun. 8, 2016
(86) PCT No.: PCT/DE2016/200265

§ 371 Date: Feb. 19, 2018

(30) Foreign Application Priority Data
Aug. 17, 2015 (DE) 10 2015 215 610.9

(51) Int. Cl. F16C 33/58; B23P 15/00; B21D 53/10; F16C 19/36; F16C 43/04

(52) U.S. Cl. CPC F16C 33/586; B23P 15/003; F16C 2223/10; F16C 19/364; F16C 43/04; B21D 53/10

(57) ABSTRACT

A method is disclosed for producing a tapered roller assembly which can be mounted in a particularly simple manner. For this purpose, a method for producing a tapered roller assembly having an inner ring and a roller ring is proposed, wherein the method comprises the following steps: a) providing the inner ring , wherein the inner ring has a flanged mounting rim which is produced within a preliminary flanging stage by flanging over an edge region of the inner ring; b) mounting the roller ring on the inner ring, wherein the roller ring is pushed over the flanged mounting rim onto the inner ring; c) flanging over the flanged mounting rim into a flanged rim wherein the flanged rim, as a retaining rim, captively retains the roller ring; and d) heat treating the flanged mounting rim before step b) or step c), wherein a hardness of the flanged mounting rim is reduced by comparison with a hardness of a raceway of the inner ring. Also proposed is a tapered roller bearing formed with such a tapered roller assembly.

### TECHNICAL FIELD

The invention relates to a method for manufacturing a tapered roller assembly, wherein the method comprises the steps of: providing the inner ring, wherein the inner ring has a flanged mounting rim; mounting a roller ring on the inner ring, wherein the roller collar is pushed onto the inner ring via the flange mounting plate; and flanging the flanged mounting rim into a flanged rim, wherein the flanged rim retains the roller ring as a holding board. The invention also relates to a tapered roller assembly which is produced by the method, as well as a tapered roller bearing formed with the tapered roller assembly.

### BACKGROUND

In many designs, tapered roller bearings have an inner ring, an outer ring, and a plurality of tapered rollers arranged between the inner ring and the outer ring.

The tapered rollers are often guided in a cage. The manufacturing of the inner ring and the outer ring can, for example, be machined by removing the inner rings from a semi-finished product. Other possibilities provide for the rings to be produced by means of forming technology.

Thus, document DE 102011005326 A1 discloses a method for the production of a bearing ring—in particular, a tapered roller bearing ring—wherein, starting from a circular ring disc, a formation of a substantially cylindrical bearing ring and the production of a runway of the bearing ring take place in a single working step through a forming step—in particular, a flow press.

DE1014795 B discloses a needle bearing with axial guiding of the needle rim on both sides through a hardened bearing ring with rims formed on both sides, One of the rims is formed after the axial assembly of the cage and the bearing ring, wherein the material is in the soft state in the region of this flange and is hardened only after the forming. The bearing ring has a reduced wall thickness in the area of the rim formed after mounting the cage.

JP 2015-025503 A describes a tapered roller bearing and a method of manufacturing the same, wherein an inner ring is provided which has a small flange and a large flange. A roll ring is mounted on the inner ring, wherein the roller rim is pushed onto the inner ring via the soft-annealed small flange, and the small flange is subsequently formed in order to captively retain the roller rim as a retaining rim. In this case, the small flange is folded in the direction of the tapered rollers in a forming step, wherein high levels of forming are achieved. In that way, surface defects already present in the region of the strongest deformation are further intensified. There are also additional defects in the material of the inner ring, such as cracks or crinkles which lead to a further weakening of the crimped small flange.

### BRIEF SUMMARY

It is an aim of the present invention to propose a method for producing a tapered roller assembly which can be mounted particularly simply and securely. This aim is achieved by a method with the features of claim 1 and by a tapered roller assembly having the features of claim 10. Furthermore, the aim of the invention is to provide a tapered roller bearing with such a tapered roller assembly. Preferred or advantageous embodiments of the invention result from the dependent claims, the following description, and the appended figures.

The aim is achieved for the method for producing a tapered roller assembly having an inner ring and a roller rim, wherein the method comprises the steps of:
a) providing the inner ring, wherein the inner ring has a flanged mounting rim, which is produced in the context of a preliminary flanging stage by flanging an edge region of the inner ring;
b) mounting the roller rim on the inner ring, wherein the roller rim is pushed onto the inner ring via the flanged mounting rim;
c) flanging the flanged mounting rim into a flanged rim, wherein the flanged rim retains the roller rim captive as a holding board;
d) heat treating the flanged mounting rim before step b) or step c), wherein a hardness of the flanged mounting rim is reduced in contrast to a hardness of a runway of the inner ring.

A subject matter of the invention is a method for producing a tapered roller assembly. The tapered roller assembly has an inner ring and a roller rim. The roller rim comprises a plurality of tapered rollers and a cage in which the tapered rollers are held. It is preferably provided that the inner ring and the cage hold the tapered rollers in the radial direction in a captive manner. Thus, the tapered rollers are supported radially inwards by the inner ring and are captured radially outwards by the cage. The inner ring has a flanged rim and a runway on which the tapered rollers roll. Optionally, the inner ring further has a fixed rim. The runway is arranged in the axial direction between the flanged rim and the fixed rim. The runway preferably has a frustoconical or conical surface. Preferably, the inner ring is made of steel—in particular, a hardenable steel. On the inner circumferential surface, the inner ring is formed preferably to be straight and hollow-cylindrical. The roller rim is arranged between the flanged board and the fixed rim—in particular, in such a way that the roller rim is captured in a positive fit in both axial directions. In particular, the tapered roller assembly comprising the inner ring and the roller rim is formed as a self-supporting assembly, which is easy to transport and/or mount, since no components of the tapered roller assembly can be lost.

The method comprises at least the following steps:

Firstly, the inner ring is provided in a preliminary flanging stage, wherein the inner ring has a flanged mounting rim and, optionally supplemental, the fixed rim. The flanged mounting rim and the fixed rim are arranged at axially opposite ends of the inner ring. The runway for the tapered rollers is arranged between the flanged mounting rim and the fixed rim. The flanged mounting rim is preferably formed as an axial end portion of the inner ring, which is expanded radially outwards with respect to an—in particular—imaginary, cylindrical extension of the inner ring. In a longitudinal section through the inner ring along an axis of rotation of the inner ring, the flanged mounting rim extends radially outwards from the transition from the runway of the inner ring. Radially, on the inside and/or on the outside, the flanged mounting rim is, for example, designed in a tapered or conical shape.

In a subsequent step of a mounting stage, the roller rim is mounted on the inner ring, wherein the roller rim is pushed onto the inner ring via the flanged mounting rim. The roller rim is preferably designed as a pre-assembled roller rim, wherein all the tapered rollers are already arranged inside the cage. The tapered rollers are secured by the cage against falling out in the radial direction to the outside. In other words, the tapered rollers are captive inside the cage with respect to a radial outward direction. Thus, the roller rim comprising the cage and the tapered rollers—in particular, all the tapered rollers—is pushed onto the inner ring via the flanged mounting rim. In particular, it is provided that the cage of the roller rim not be bulging or otherwise deformed during the pushing on, but rather that the cage with the tapered rollers, and thus the roller rim, be dimensioned in such a way that this is pushed onto the inner ring—preferably, without deformation—by the flanged mounting rim.

In a subsequent step of a final flanging stage, the flanged mounting rim is crimped, so that the flanged rim is created. The flanged rim is designed as a holding board, which holds the roller rim captive and/or in a positive fit in the axial direction. In particular, the flanged mounting rim is further folded in the direction of the runway, so that the roller rim is caught in or on the inner ring.

It is thereby an advantage of the invention that the flanged board is created in two steps, wherein, first, the flanged mounting board is manufactured, the roller rim is, subsequently, mounted, and only then does the formation into the flanged rim take place. In this way, the tapered roller assembly can be easily mounted without having to bulge or otherwise deform the cage of the roller rim. Nevertheless, after the process has been completed, the roller rim is held captive in or on the inner ring, so that the tapered roller assembly can be transported and mounted without the risk that components or parts of the tapered roller assembly are lost.

According to the invention, the flanged mounting rim is heat-treated—in particular, locally—to reduce the hardness of the flanged mounting rim for the flanging into the flanged rim. In particular, the inner ring is locally heat-treated in the region of the flanged mounting rim—especially in the bending region of the final flanging stage. On the other hand, the heat treatment is preferably implemented such that the hardness of the runway remains unchanged. Particularly preferably, the hardness of the flanged mounting rim—in particular, in the region of the change in form of the flanging in the final flanging stage—is made lower by the heat treatment, in comparison with the runway of the inner ring. Due to the two-stage flanging and the heat treatment between the two flanging operations, the material hardening in the edge region of the inner ring in the flanging end stage is reduced to such an extent that a risk of material damage—in particular, a formation of cracks or folds—is minimized in this region of the inner ring. As a result, during the assembly of a tapered roller assembly according to the invention, wherein the inner ring is pushed onto a shaft, no damage occurs at the flanged rim in the area of the flanged rim, since the latter, because of the two-stage method, has a still sufficient residual ductility to elastically yield to an assembly tool pressed against it. Furthermore, advantageously, the assembly time in the final flanging stage is also reduced, because of the shorter path by which the pre-crimped flanged mounting rim has to be further formed.

The basic hardness of the inner ring without local heat treatment can, for one thing, be due to the manufacture of the inner ring. For example, in the case of a forming process production such as a preferred cold-flow press, stresses occur, which lead to material solidification. Alternatively or additionally, the inner ring can also be hardened in its entirety, wherein the hardness is locally again reduced by the local heat treatment. It may also be that the base material of the inner ring has a basic hardness, which is reduced by the—in particular—local heat treatment.

The heat treatment can, according to choice, be carried out before the assembly of the roller rim or after the assembly of the roller rim. However, it is preferable to carry out the heat treatment before mounting the roller rim, so as to avoid accessibility problems, since the roller rim may represent an interference contour for the heat treatment.

The advantage of the—in particular, local—heat treatment is that, on the one hand, the flanging of the flanged mounting rim in the flanged rim is simplified, since the bending region is less hard. Furthermore, in this way, cracks in the area of the bending region of the flanged mounting rim or the flanged rim are avoided. It is particularly preferable that the heat treatment be formed as a high-frequency heat treatment.

According to the invention, the flanged mounting rim is produced in the context of a preliminary flanging stage by a flanging of an edge region of the inner ring. Looking at the inner ring in the course of production, an edge region of the inner ring is initially provided, which extends, for example, in the axial direction in the manner of a hollow cylinder. In the preliminary flanging stage, the edge region is flanged and inserted in the direction of the runway so that the subsequent assembly of the roller rim can take place.

In this case, it is preferred if the flanged mounting rim is formed in the preliminary flanging stage so as to form an angle with the raceway of the inner ring which is in the range of 90 to 180°.

After assembly of the roller rim, the final flanging stage is carried out, wherein the flanged mounting rim is further folded in the direction of the runway, to form the flanged rim. In this case, the flanged rim is, in particular, designed in such a way that it encloses an angle with the runway of the inner ring which is in the range of less than 90°.

In terms of production technology, it is preferred that the flanging be implemented in the preliminary flanging stage by means of a flange punch, which can be moved in the axial direction and applies an axial force to the edge region of the inner ring, to form the latter into the flanged mounting rim.

It is particularly preferred for the inner ring to be produced with the edge region by means of cold-flow pressing. A forming device is particularly preferably used for cold-flow pressing. It is particularly preferred if the cold-pressed inner ring—in particular, in the region of its runway—has no surfaces influenced by material separation processes.

In a preferred development of the method, the flanging into the preliminary flanging stage is performed when the inner ring is still inserted with the edge region into the forming device. In this position, the inner ring is defined in a position such that the edge region can be formed with sufficient precision into the flanged mounting rim.

Particularly preferably, the forming device has at least one tool part, which conforms at least to the raceway, and a forming punch, wherein the forming punch is moved in the axial direction. It is particularly preferred in this case for the flanging punch to be moved into the counter-direction.

Particularly preferably, the inner ring with the edge region is produced from a circular ring disk—in particular, a flat circular ring disk—which is formed with the forming device into the inner ring by cold-flow pressing.

The invention further relates to the tapered roller assembly which is produced by the method according to the invention, The hardening course resulting from the method in the inner ring with the flanged rim, as installed in the tapered roller assembly, is characteristic, and can demonstrate the use of the method according to the invention.

In this case, it is preferable for the tapered roller assembly if the inner ring, which is pressed, in particular, by cold flow, has a maximum thickness of 6 mm in the region of the runway. Furthermore, the cold-pressed inner ring in the edge region preferably has a thickness which corresponds to at least 25% of this maximum thickness of the runway.

The aim is further achieved for a tapered roller bearing comprising a tapered roller assembly according to the invention, as well as an outer ring. The same advantages apply for the tapered roller bearing as for the tapered roller assembly according to the invention, as already mentioned above.

The outer ring of the tapered roller bearing is, in particular, a cold-pressed outer ring.

Particular preference is given to a tapered roller bearing in which the inner ring and the outer ring are produced by cold-flow pressing and have, particularly in the region of the runway of the inner ring and a runway of the outer ring, no surfaces influenced by material separation processes. Such a bearing is particularly fast and inexpensive to manufacture, and has excellent mountability and durability.

Further features, advantages, and effects of the invention will become apparent from the following description of preferred exemplary embodiments of the invention, as well as from the appended figures. The following is shown:

### BRIEF DESCRIPTION OF THE FIGURES

FIG. 1 shows a flow diagram with several steps of a method for producing a tapered roller assembly;

FIG. 2 shows a forming device in a half-section for producing an inner ring for the tapered roller assembly in a highly schematic representation; and

FIG. 3 shows a tapered roller bearing according to the invention in a half-section.

### DETAILED DESCRIPTION

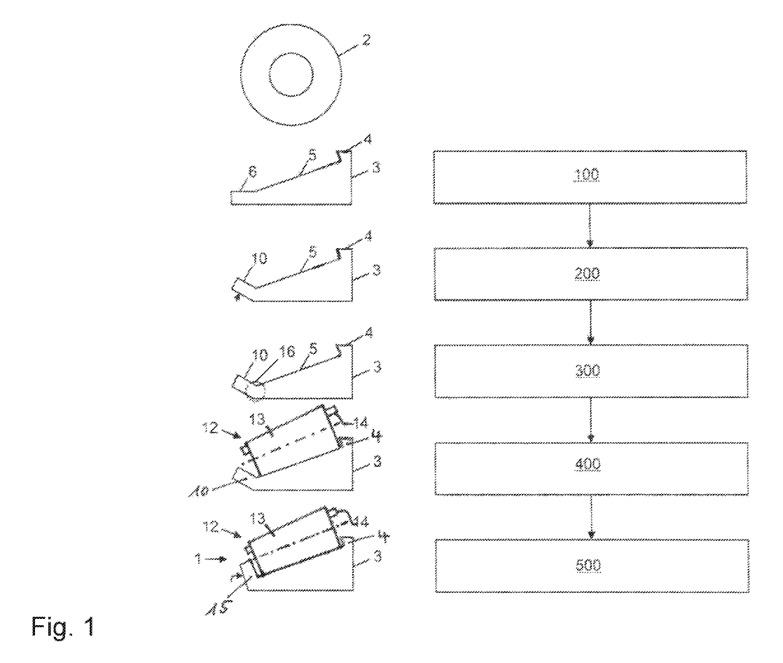

On the right-hand side, FIG. 1 shows a flow diagram with several steps for producing a tapered roller assembly 1. On the left-hand side, the starting products or intermediate products for the production of the tapered roller assembly 1 are shown schematically in half-section.

The process can proceed, for example, from a circular ring disk 2, which is made of a preferably hardenable steel. The circular ring disk 2 is designed as a flat disk and can, for example, be cut out from a circular blank. In a step 100, which is designed as a forming step, the circular ring disk 2 is formed by cold-flow pressing into an inner ring 3, wherein the inner ring 3 has a fixed rim 4, a conical raceway/runway 5, and an edge region 6 running in an axial direction. The edge region 6 is designed as a hollow-cylindrical end portion of the inner ring 3.

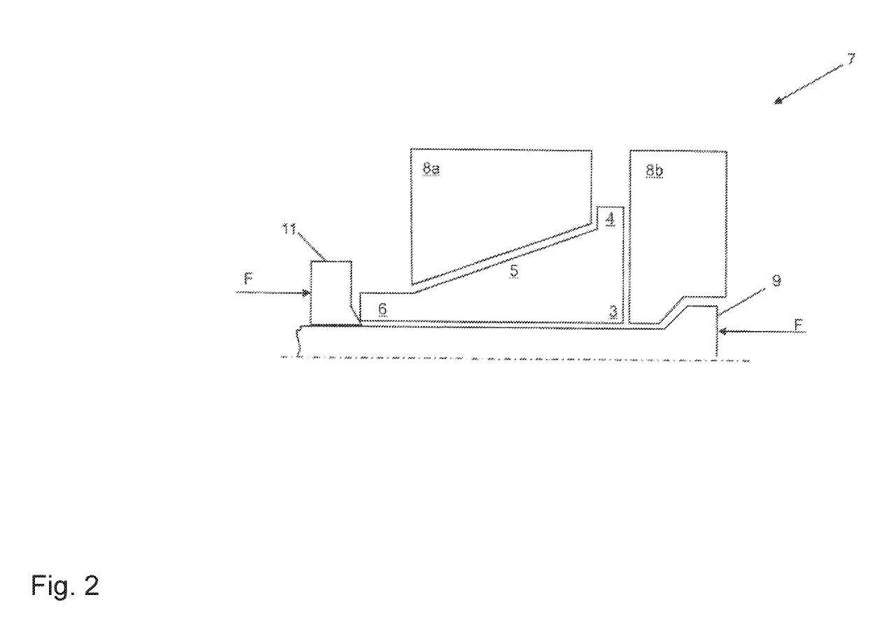

For example, the inner ring 3 can be produced in the state after step 100 in a forming device 7, as shown schematically in a half-section in FIG. 2. The forming device 7 has two tool parts 8a, b, wherein the tool part 8a forms the runway 5 of the inner ring 3, and the tool part 8b forms an end face of the inner ring 3 on the fixed rim 4. Between the tool parts 8a and 8b, the circular ring disk 2 is inserted and formed into the shape of the inner ring 3 by means of a central forming punch 9 by means of cold-flow pressing. In this case, the edge region 6 is formed by an annular gap between the tool part 8a and the forming punch 9.

In a step 200, which is designed as a preliminary flanging stage, the edge region 6 is folded or crimped in the direction of the runway 5. In this case, a flanged mounting rim 10 is produced, which has a conical, circumferential surface on the radial inner side and on the radial outer side. The edge region 6 has been formed from the hollow-cylindrical shape into a funnel shape by the forming in the preliminary flanging stage in step 200.

A possible implementation of step 200 is shown in FIG. 2. As soon as the inner ring 3 is produced with the edge region 6, a flanging punch 11 is set in the axial direction, so that the edge region 6 is formed into the flanged mounting rim 10 in the manner described. The feed direction of the flanging punch 11 is counter to the feed direction of the forming punch 9, represented by the applied forces F acting in opposite directions by means of flanging punch 11 and forming punch 9, respectively,

In a step 300, which is designed as a heat treatment stage, a local heat treatment of the flanged mounting rim 10 takes place, and, in fact, particularly in the connection region 16 to the runway 5. The local heat treatment can, for example, be carried out by a high frequency heat treatment. As a result of the local heat treatment, the connection region 16 of the flanged mounting rim 10 is made softer than, for example, the runway 5, so that further flanging of the flanged mounting rim 10 is simplified. Furthermore, fractures and cracks are avoided during further flanging.

In a step 400, which is designed as a mounting stage, a roller rim 12 is assembled, wherein the roller rim 12 comprises a plurality of tapered rollers 13 and a cage 14, in which the tapered rollers 13 are arranged. The cage 14 is designed such that the tapered rollers 13 are held captive between the cage 14 and the runway 5. In particular, the tapered rollers 13 cannot emerge outward from the cage 14 in a radial direction. The geometry of the flanged mounting rim 10 is selected in such a way that the interference contour diameter formed by the flanged mounting rim 10 is smaller than a free diameter of the roller rim 12, so that the roller rim 12 can be pushed or mounted onto the inner ring 3 without deformation of the cage 14. In particular, the selection of a suitable dimensioning avoids damage to the cage 14 in the mounting stage.

In a step 500, which is designed as a final flanging stage, the flanged mounting rim 10 is further bent or crimped into a flanged rim 15. Thus, the edge region 6 is folded in two steps in the direction of the runway 5. The flanged rim 15 is designed as a retaining rim, which holds the roller rim 12, including the tapered rollers 13 and the cage 14, captive. As a result, the end product, i.e., the tapered roller assembly 1, is designed as a self-supporting assembly which can be easily transported and assembled.

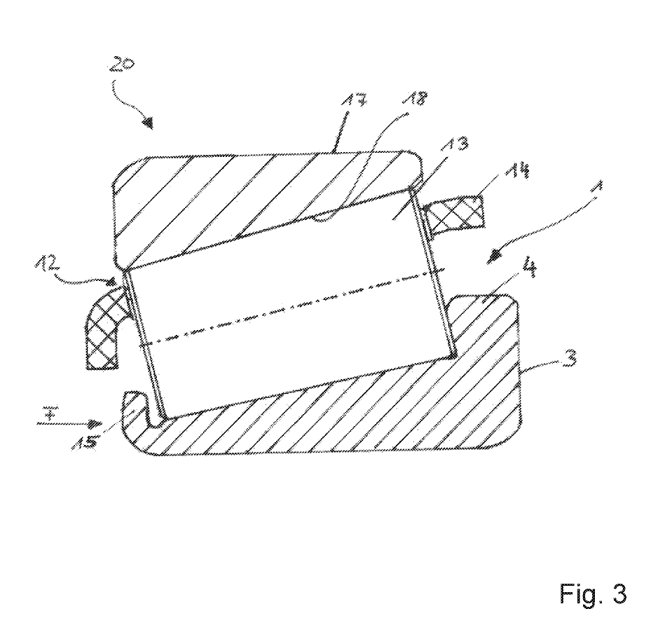

FIG. 3 shows a tapered roller bearing 20 in half-section with a tapered roller assembly 1 according to FIG. 1, step 500, after the final flanging stage. The roller rim 12 comprising the cage 14 and the tapered rollers 13, as well as the inner ring 3 with the fixed rim 4 and the flanged rim 15, can be seen. Furthermore, an outer ring 17 with a raceway/runway 18 is provided. When the tapered roller bearing 20 is mounted on a shaft, wherein the inner ring 3 is pushed onto the shaft, an assembly tool is pressed axially with a force F against the inner ring 3 in the region of the flanged rim 15. In the region of the flanged rim, no damage occurs, because, due to the two-stage method and the associated reduced material hardening in the final flanging stage, the flanged rim still has sufficient residual ductility to elastically yield to the assembly tool pressed against it.

### LIST OF REFERENCE NUMERALS

1 Tapered roller assembly
2 Circular ring disk
3 Inner ring
4 Fixed rim
5 Raceway/Runway
6 Edge region
7 Forming device
8a, b Tool parts
9 Forming punch
10 Flanged mounting rim
11 Flanging punch
12 Roller ring
13 Tapered rollers
14 Cage
15 Flanging rim
16 Connecting region
17 Outer ring
18 Raceway/Runway
20 Tapered roller bearing
F Force

1. A method for producing a tapered roller assembly having an inner ring and a roller ring, comprising:
providing the inner ring, wherein the inner ring has a flanged mounting rim which is produced in the context of a preliminary flanging stage by flanging an edge region of the inner ring;
mounting the roller ring on the inner ring, wherein the roller ring is pushed onto the inner ring via the flanged mounting rim;
flanging the flanged mounting rim into a flanged rim, wherein the flanged rim retains the roller ring captive as a retaining rim;
heat treating the flanged mounting rim before the mounting step or the flanging step, wherein a hardness of the flanged mounting rim is reduced in comparison with a hardness of a raceway of the inner ring.

2. The method according to claim 1, wherein the flanged mounting rim is formed in the preliminary flanging stage so as to form an angle with the raceway of the inner ring which is in the range of 90 to 180°.

3. The method according to claim 1, wherein the flanged rim is formed in such a way that it encloses an angle which is in the range of less than 90° with the raceway of the inner ring.

4. The method according to claim 1, wherein the heat treatment is performed as an RF heat treatment.

5. The method according to claim 1, wherein a cold-flow pressed inner ring is used as the inner ring.

6. The method according to claim 5, wherein the cold-flow pressed inner ring, in a region of the raceway, has no surfaces influenced by material separation processes.

7. The method according to claim 1, wherein the flanging of the flanged mounting rim in the preliminary flanging stage is implemented by a flanging punch moved in the axial direction.

8. The method according to claim 6, wherein cold-flow pressing of the inner ring takes place by a forming device with at least one tool part which conforms to at least the raceway, wherein the forming device has a forming punch, wherein the forming punch is moved in the axial direction.

9. The method according to claim 8, wherein the flanging punch and a forming punch are moved in opposite directions.

10. A tapered roller assembly, wherein the tapered roller assembly is produced by the method according to claim 1.

11. The tapered roller assembly according to claim 10, wherein the inner ring has a maximum thickness of 6 mm in the region of the raceway.

12. The tapered roller assembly according to claim 11, wherein the inner ring has a thickness in the edge region which corresponds to at least 25% of the maximum thickness of the raceway.

13. A tapered roller bearing comprising a tapered roller assembly according to claim 10 further comprising an outer ring.

14. The tapered roller bearing according to claim 13, wherein the outer ring is a cold-flow pressed outer ring.

15. The tapered roller bearing according to claim 13, wherein the inner ring and the outer ring are produced by cold-flow pressing, and, particularly in a region of the raceway of the inner ring and a raceway of the outer ring, have no surfaces influenced by material separation processes.
